(19) United States
(12) Patent Application Publication
(10) Pub. No.: US 2016/0036701 A1
(43) Pub. Date: Feb. 4, 2016

(54) METHODS AND ARRANGEMENTS TO SIGNAL AN ACKNOWLEDGEMENT POLICY IN A SHORT FRAME

(71) Applicant: Minyoung PARK, Portland, OR (US)

(72) Inventor: Minyoung Park, Portland, OR (US)

(21) Appl. No.: 14/779,999

(22) PCT Filed: Dec. 28, 2013
(86) PCT No.: PCT/US13/78159

§ 371 Date: Sep. 25, 2015

Related U.S. Application Data
(60) Provisional application No. 61/820,512, filed on May 7, 2013.

(51) Int. Cl. H04L 12/741; H04L 29/06; H04W 72/04

(52) U.S. Cl. CPC H04L 45/74; H04W 72/04; H04L 69/22

(57) ABSTRACT

Logic may define a new short frame format with an acknowledgement (ACK) policy field. Logic may define the new short frame format to include an ACK policy field as a subfield of a frame control field in the new short frame format. Logic may define the new short frame format with a truncated and redefined type field and a new ACK policy subfield in a frame control field to minimize impact of the introduction of the new short frame format. Logic may implement a short frame format with a redefined frame control field with respect to a current short frame format. Logic may define the ACK policy subfield to include more than one ACK policy such as a normal ACK, a block ACK, and a no ACK to increase the utility of the short frame format and to increase device compatibility with devices of different designs and from different vendors.

### TECHNICAL FIELD

Embodiments are in the field of wireless communications. More particularly, embodiments are in the field of communications protocols between wireless transmitters and receivers.

### BACKGROUND

A wireless communications system may utilize bi-directional signaling of control information to coordinate operations between geographically disparate communications devices. A design tradeoff for a wireless communications system is balancing a volume of control information and data information for a given amount of system bandwidth. An increase in control information, sometimes referred to as overhead, may reduce system bandwidth available for data transmissions. Balances are determined between the inclusion of more control information in protocols for systems and the inclusion of less information in protocols for systems. A factor in determining the balance rests in the intended usage for devices using the different protocols. In some systems, for instance, some of the devices may utilize an electrical power source, fast data rates, and other favorable environmental factors that may push the balance towards increased overhead in order to achieve some benefit from the increased overhead. Other devices may utilize battery power, have low data rates, and possibly be subject to other environmental factors that push the balance towards reduced overhead for data transmissions. However, reductions in control information may cause problems in managing bi-directional signaling. Reductions in control information may reduce or eliminate such management features, thereby causing potentially unreliable communications.

### BRIEF DESCRIPTION OF THE DRAWINGS

FIG. 1 depicts an embodiment of a wireless network comprising a plurality of communications devices, including multiple fixed or mobile communications devices;

FIG. 1A depicts an embodiment of a short frame format;

FIG. 1B depicts an embodiment of a frame control field of a short frame format;

FIG. 2 depicts an embodiment of an apparatus to generate, transmit, receive, decode, and interpret a short frame with an acknowledgement policy field;

FIGS. 3A-B depict embodiments of flowcharts to generate a short frame with an acknowledgement policy field; and

FIGS. 4A-B depict embodiments of flowcharts to transmit, receive, decode, and interpret communications with short frames with acknowledgement policy fields as illustrated in FIGS. 1-2.

### DETAILED DESCRIPTION OF EMBODIMENTS

The following is a detailed description of novel embodiments depicted in the accompanying drawings. However, the amount of detail offered is not intended to limit anticipated variations of the described embodiments; on the contrary, the claims and detailed description are to cover all modifications, equivalents, and alternatives falling within the spirit and scope of the present teachings as defined by the appended claims. The detailed descriptions below are designed to make such embodiments understandable to a person having ordinary skill in the art.

References to “one embodiment,” “an embodiment,” “example embodiment,” “various embodiments,” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Short frames may be frames in which the control information in a communication is reduced to reduce the overhead involved with communications. For example, the Institute of Electrical and

Electronic Engineers (IEEE) 802.11 ah defines a short medium access control (MAC) frame format to reduce the MAC header overhead by removing some of the existing fields of the MAC header. Several embodiments may benefit significantly from the reduced overhead in the existing MAC header. Some embodiments, for instance, implement a 1 Megahertz (MHz) channel bandwidth for the IEEE 802.11 ah systems. The lowest data rate in such embodiments may be approximately 6.5 Megabits per second (Mbps) divided by 20=325 Kilobits per second (Kbps). If two times repetition coding is used, the lowest data rate drops to 162.5 Kbps. In many embodiments, the lowest PHY rate is used for beacon and control frame transmissions. Although lowering the data rate may increase the transmission range, it takes a much longer time to transmit a packet. According to one embodiment, the efficiency of the protocol may be improved by reducing MAC headers of the packets to be short MAC headers, which can enable small battery-powered wireless devices (e.g., sensors) to use Wi-Fi to connect to the, e.g., Internet with very low power consumption.

IEEE 802.11 systems typically use a media access control (MAC) frame format to convey control information. A MAC header (not short), however, may introduce significant overhead, particularly for a shorter payload, or MAC protocol data unit (MPDU). For instance, an IEEE 802.11n system may utilize a MAC header comprising 30-36 octets, without security. This is inefficient for short-packet applications, such as traffic for sensors and industrial process automation, for example.

IEEE 802.11ah defines a short media access control (MAC) frame format to reduce MAC header overhead by removing some of the existing fields of the MAC header. The short MAC frame format may be used to shorten a MAC header, which in turn may prolong battery life for a device and reduce medium occupancy. One of the fields removed from the short MAC frame format is an acknowledgement policy field, which is typically part of a quality of service (QoS) control field of a normal MAC frame format.

The acknowledgement policy field may indicate whether a particular acknowledgement policy should be used for a given connection, device or system. For instance, a device could use a normal acknowledgement (ACK) scheme, a block ACK scheme, or no ACK scheme at all. Absence of the acknowledgement policy field in a short MAC frame format may lead to unreliable communications, particularly for QoS applications. Furthermore, the absence of the ACK Policy field may effectively restrict the ability of devices to use the low overhead short frame in situations in which more than one ACK policy is useful or may prevent devices that may only use the short frame from engaging in communications that require usage of more than one ACK policy.

Many embodiments implement a protocol to enable signaling of acknowledgement policies in short frames to solve these and other problems by implementing techniques to signal an acknowledgement policy for WLAN systems utilizing abbreviated MAC signaling, such as the short MAC frame format of an IEEE 802.11ah system, for example. Embodiments may comprise logic such as hardware and/or code to enable signaling of acknowledgement policies in a short frame by determining a short frame, transmitting the short frame, communicating that the frame is a short frame, and parsing, decoding, and interpreting the short frame at the receiving device.

Embodiments may define a new short frame format with an acknowledgement (ACK) policy field. Many embodiments may define the new short frame format to include an ACK policy field as a subfield of a frame control field in the new short frame format. Several embodiments may implement a short frame format with a redefined frame control (FC) field with respect to a current short frame format to minimize impact of the introduction of the new short frame format. In one embodiment, a current FC field of a short MAC frame format is redefined to reserve one or more bits for use as an acknowledgement policy field. As a result, the embodiments can improve affordability, scalability, modularity, extendibility, or interoperability for an operator, device or network. Some embodiments may define the new short frame format with a truncated and redefined type field and a new ACK policy subfield in a frame control field. Many embodiments may define the ACK policy subfield to include more than one ACK policy such as a normal ACK, a block ACK, and a no ACK to increase the utility of the short frame format and to increase device compatibility with devices of different designs and from different vendors.

In several embodiments, the frame control (FC) field may comprise a number of subfields including the type subfield and the traffic identifier (TID) subfield. The type subfield may be reduced from a four bit field to a two bit field and be redefined in a manner that communicates the current type subfield's information. For instance, the type subfield in the IEEE 802.11ah system short frame may communicate that the type of frame as being a data frame bit sequence 0000 or a management frame with bit sequence 0001 and may have a reserved bit sequence 1111 that is currently reserved. The remaining bit sequences are reserved. The type subfield may be redefined to utilize two of the bits for an ACK policy.

In some embodiments, the type subfield may be redefined to utilize two bits. In such embodiments, the two bit sequences may be defined as or redefined to identify a data type frame 00, a management type frame 01, a reserved frame 10, and possibly an extension frame or another reserved frame 11.

Embodiments may define a new subfield with 2 bits such as the two bits recaptured from the type subfield to create a new ACK policy that defines four different policies. For instance, some embodiments may define a two bit ACK policy subfield to provide at least a normal ACK, a Block ACK, and a no ACK. The inclusion of these additional ACK policies can significantly improve communications between devices designed by various vendors. In further embodiments, the two bit ACK policy may comprise, for example, ACK policies including a normal ACK, a No ACK, a No explicit ACK, and a block ACK. In further embodiments, the two bit ACK policy may comprise, for example, ACK policies including a normal ACK or implicit ACK bit sequence 00, a No ACK bit sequence of 10, a No explicit ACK or power save multi-poll (PSMP) ACK bit sequence 01, and a block ACK with bit sequence 11. Many embodiments implement frame subtypes in a traffic identifier (TID) subfield of the frame control field of a short frame.

Various embodiments may be designed to address different technical problems associated with system overhead and the lack of an ACK policy in the short frame formats for communications. Other technical problems may include the lack of bits available in the short frame formats to define an ACK policy, redefining bits in a field, truncating or compressing a field value, and/or the like.

Different technical problems such as those discussed above may be addressed by one or more different embodiments. For instance, some embodiments that address system overhead and the lack of an ACK policy in the short frame formats for communications may do so by one or more different technical means such as determining one or more subfields that can be redefined to utilize to define an ACK policy field, redefining the one or more subfields to avoid unnecessary loss of currently defined functionality, and defining the new ACK policy subfield in the frame control field of a short frame format.

Some embodiments implement Institute of Electrical and Electronic Engineers (IEEE) 802.11 systems such as IEEE 802.11ah systems and other systems that operate in accordance with standards such as the IEEE 802.11-2012, IEEE Standard for Information technology—Telecommunications and information exchange between systems—Local and metropolitan area networks—Specific requirements—Part 11: Wireless LAN Medium Access Control (MAC) and Physical Layer (PHY) Specifications (http://standards.ieee.org/getieee802/download/802.11-2012.pdf).

Some embodiments are particularly directed to improvements for wireless local area network (WLAN), such as a WLAN implementing one or more Institute of Electrical and Electronics Engineers (IEEE) 802.11 standards (sometimes collectively referred to as “Wi-Fi”, or wireless fidelity). In one embodiment, for example, an improved acknowledgement scheme may be implemented for a WLAN such as the IEEE 802.11ah wireless communications standard. The embodiments, however, are not limited to this example.

Several embodiments comprise access points (APs) for and/or client devices of APs or stations (STAs) such as routers, switches, servers, workstations, netbooks, mobile devices (Laptop, Smart Phone, Tablet, and the like), as well as sensors, meters, controls, instruments, monitors, appliances, and the like. Some embodiments may provide, e.g., indoor and/or outdoor “smart” grid and sensor services. For example, some embodiments may provide a metering station to collect data from sensors that meter the usage of electricity, water, gas, and/or other utilities for a home or homes within a particular area and wirelessly transmit the usage of these services to a meter substation. Further embodiments may collect data from sensors for home healthcare, clinics, or hospitals for monitoring healthcare related events and vital signs for patients such as fall detection, pill bottle monitoring, weight monitoring, sleep apnea, blood sugar levels, heart rhythms, and the like. Embodiments designed for such services may generally require much lower data rates and much lower (ultra low) power consumption than devices provided in IEEE 802.11n/ac systems.

Logic, modules, devices, and interfaces herein described may perform functions that may be implemented in hardware and/or code. Hardware and/or code may comprise software, firmware, microcode, processors, state machines, chipsets, or combinations thereof designed to accomplish the functionality.

Embodiments may facilitate wireless communications. Some embodiments may comprise low power wireless communications like Bluetooth®, wireless local area networks (WLANs), wireless metropolitan area networks (WMANs), wireless personal area networks (WPAN), cellular networks, communications in networks, messaging systems, and smart-devices to facilitate interaction between such devices. Furthermore, some wireless embodiments may incorporate a single antenna while other embodiments may employ multiple antennas. The one or more antennas may couple with a processor and a radio to transmit and/or receive radio waves. For instance, multiple-input and multiple-output (MIMO) is the use of radio channels carrying signals via multiple antennas at both the transmitter and receiver to improve communication performance.

This disclosure is not limited to WLAN related standards, but may also apply to wireless wide area networks (WWANs) and 3G or 4G wireless standards (including progenies and variants) related to wireless devices, user equipment or network equipment included in WWANs. Examples of 3G or 4G wireless standards may include without limitation any of the IEEE 802.16m and 802.16p standards, 3rd Generation Partnership Project (3GPP) Long Term Evolution (LTE) and LTE-Advanced (LTE-A) standards, and International Mobile Telecommunications Advanced (IMT-ADV) standards, including their revisions, progeny and variants. Other suitable examples may include, without limitation, Global System for Mobile Communications (GSM)/Enhanced Data Rates for GSM Evolution (EDGE) technologies, Universal Mobile Telecommunications System (UMTS)/High Speed Packet Access (HSPA) technologies, Worldwide Interoperability for Microwave Access (WiMAX) or the WiMAX II technologies, Code Division Multiple Access (CDMA) 2000 system technologies (e.g., CDMA2000 1xRTT, CDMA2000 EV-DO, CDMA EV-DV, and so forth), High Performance Radio Metropolitan Area Network (HIPERMAN) technologies as defined by the European Telecommunications Standards Institute (ETSI) Broadband Radio Access Networks (BRAN), Wireless Broadband (WiBro) technologies, GSM with General Packet Radio Service (GPRS) system (GSM/GPRS) technologies, High Speed Downlink Packet Access (HSDPA) technologies, High Speed Orthogonal Frequency-Division Multiplexing (OFDM) Packet Access (HSOPA) technologies, High-Speed Uplink Packet Access (HSUPA) system technologies, 3GPP Rel. 8-12 of LTE/System Architecture Evolution (SAE), and so forth. The examples are not limited in this context.

While some of the specific embodiments described below will reference the embodiments with specific configurations, those of skill in the art will realize that embodiments of the present disclosure may advantageously be implemented with other configurations with similar issues or problems.

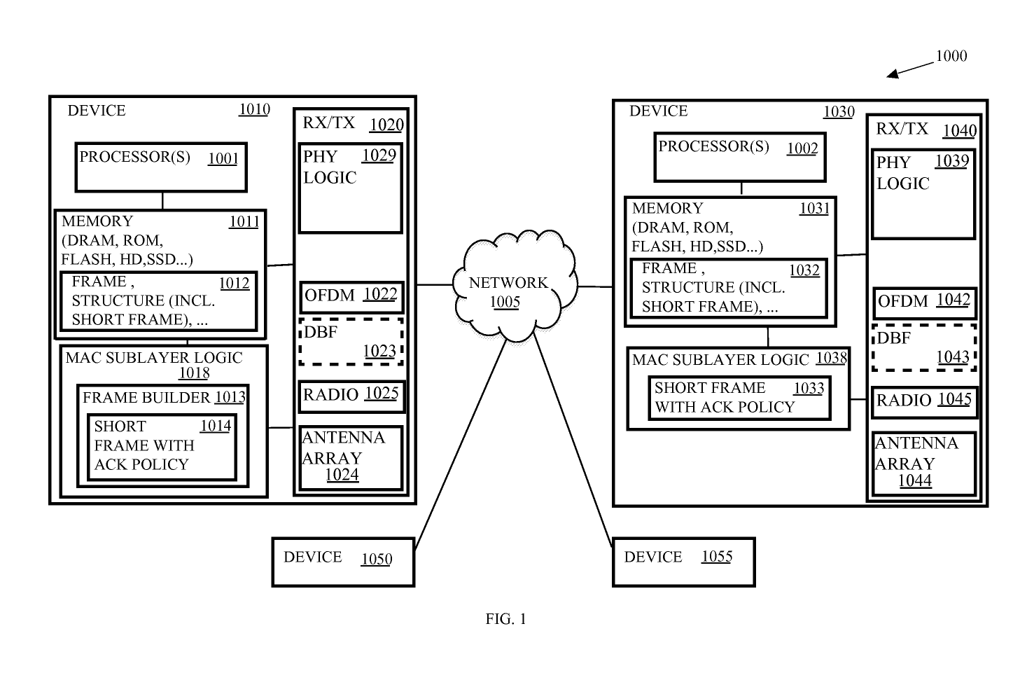

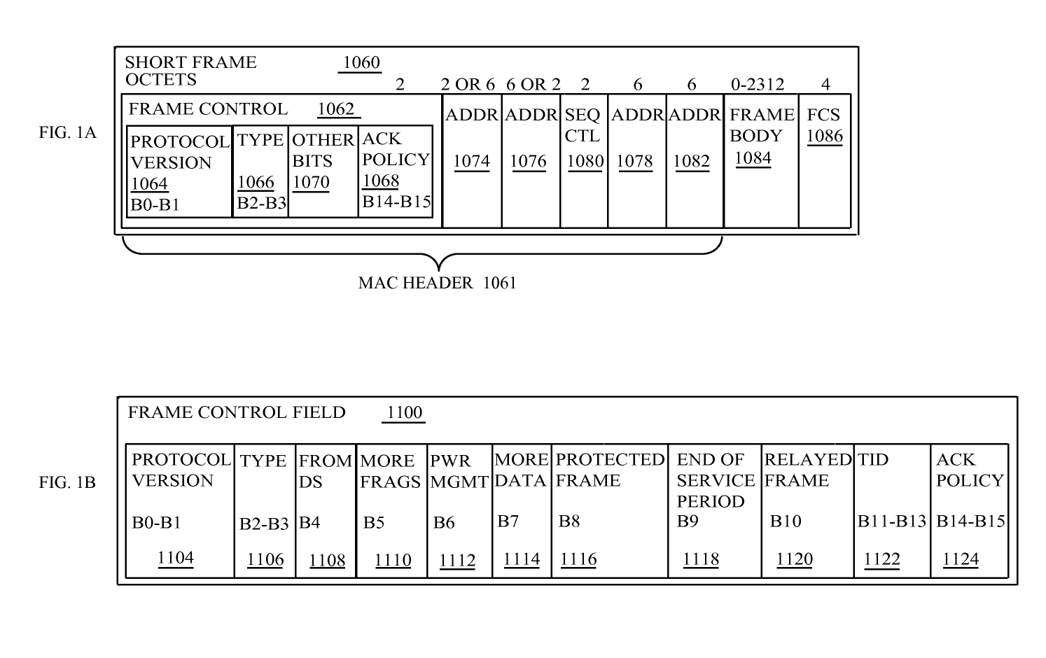

Turning now to FIG. 1, there is shown an embodiment of a wireless communication system 1000. The wireless communication system 1000 comprises a communications device 1010 that may be wire line and wirelessly connected to a network 1005. The communications device 1010 may communicate wirelessly with a plurality of communication devices 1030, 1050, and 1055 via the network 1005. The communications device 1010 may comprise an access point. The communications device 1030 may comprise a low power communications device such as a sensor, a consumer electronics device, a personal mobile device, or the like. And communications devices 1050 and 1055 may comprise sensors, stations, access points, hubs, switches, routers, computers, laptops, netbooks, cellular phones, smart phones, PDAs (Personal Digital Assistants), or other wireless-capable devices. Thus, communications devices may be mobile or fixed. For example, the communications device 1010 may comprise a metering substation for water consumption within a neighborhood of homes. Each of the homes within the neighborhood may comprise a sensor such as the communications device 1030 and the communications device 1030 may be integrated with or coupled to a water meter usage meter.

Initially, the communications device 1030 may determine a short frame 1034 to transmit. For instance, a frame builder 1033 of communications device 1030 may generate or select a short frame 1034 based upon a short frame structure 1032 in memory 1031 of communications device 1030. The medium access control (MAC) sublayer logic 1038 may communicate with the physical layer (PHY) logic 1039 to transmit the short frame 1034. In some embodiments, the PHY logic 1039 may generate a preamble with the bit indicating that the frame is a short frame. The short frame 1034 may comprise a frame with a short MAC header that is identified as a management or data frame type by a value in a type subfield, sometimes referred to as field, of a frame control field in the short frame 1034 and a particular subtype, such as a management subtype in a traffic identifier (TID) subfield of the frame control field of the short frame 1034. In further embodiments, the frame type of the short frame 1034 may be a different frame type such a new frame type defined with reserved field values such as an extension frame. Thereafter, the communications device 1030 may transmit the short frame 1034 such as a short association request frame to associate with communications device 1010.

The communications device 1010 may receive the short frame 1014 in the form of a packet. The packet may comprise the short frame 1014 and, in some embodiments, one or more additional frames, prepended by the preamble 1016. PHY logic 1029 may decode the preamble 1016 to determine the short frame 1014 and transmit the short frame 1014 to the MAC sublayer logic 1018. The MAC sublayer logic 1018 may parse the short frame 1014 based upon a short frame structure 1012 in memory 1011 and interpret one or more field values to determine that the communications device 1030 is requesting association. The communications device 1010 may transmit a short management frame such as a short association response frame to associate the communications device 1030 with the communications device 1010.

Once the communications device 1030 associates with the communications device 1010, the communications device 1030 may periodically transmit short data frames to the communications device 1010. The communications device 1010 may generate the short data frames 1033 with two bits in the type subfield of the frame control field indicative of a data frame and two bits in the ACK policy subfield of the frame control field in the short data frame 1034 with a value indicative of an ACK policy. For example, the communications device 1030 may insert a value of 00 in the type subfield to indicate that the short frame 1033 is a data frame and insert a value of 00 in the ACK policy subfield to indicate to the communications device 1010 that the ACK policy for the short data frame 1034 is a normal or implicit block ACK policy. In other situations, the communications device 1030 may insert a value of 10 in the ACK policy subfield to indicate an ACK policy of no ACK, a value of 01 to indicate a no explicit ACK or power save multi-poll (PSMP) ACK, or a value of 11 to indicate a Block ACK policy.

In response to the short data frames, the communications device 1010 may respond with an ACK in response to receipt of the short data frame 1014. Furthermore, the communications device 1030 may also periodically receive short beacon frames from the communications device 1010 of the metering substation to transmit data related to water usage. In some embodiments, the short beacon frames may include an indication that the communications device 1010 is buffering data for the communications device 1030.

In further embodiments, the communications device 1010 may facilitate data offloading. For example, communications devices that are low power sensors may include a data offloading scheme to, e.g., communicate via Wi-Fi, another communications device, a cellular network, or the like for the purposes of reducing power consumption consumed in waiting for access to, e.g., a metering station and/or increasing availability of bandwidth. Communications devices that receive data from sensors such as metering stations may include a data offloading scheme to, e.g., communicate via Wi-Fi, another communications device, a cellular network, or the like for the purposes of reducing congestion of the network 1005.

The network 1005 may represent an interconnection of a number of networks. For instance, the network 1005 may couple with a wide area network such as the Internet or an intranet and may interconnect local devices wired or wirelessly interconnected via one or more hubs, routers, or switches. In the present embodiment, the network 1005 communicatively couples communications devices 1010, 1030, 1050, and 1055.

The communication devices 1010 and 1030 comprise processor(s) 1001 and 1002, memory 1011 and 1031, and MAC sublayer logic 1018 and 1038, respectively. The processor(s) 1001 and 1002 may comprise any data processing device such as a microprocessor, a microcontroller, a state machine, and/or the like. The memory 1011 and 1031 may comprise a storage medium such as Dynamic Random Access Memory (DRAM), read only memory (ROM), buffers, registers, cache, flash memory, hard disk drives, solid-state drives, or the like. The memory 1011 and 1031 may store the frames such as the short frames and/or the short frame structures, and the memory 1011 and 1031 may store short frame headers such as short MAC headers or portions thereof. In many embodiments, the short frames may comprise fields based upon the structure of the standard frame structures identified in IEEE 802.11. FIG. 1A illustrates a short frame structure that is the same as the standard frame structure with exception of one or more of the field sizes and one or more fields that were omitted such as the Duration field and the quality of service (QoS) field.

The short frame structures may differ from the standard frame structures in the number or types of fields and/or the size of the fields included in the MAC header. For example, in a short frame, one or more or even all of the fields in the header may be truncated or omitted. In several embodiments, the type field is reduced to two bits and the subtype field is omitted. In further embodiments, the protocol field is included and is the same size as the corresponding protocol field in the standard MAC header.

FIG. 1A illustrates a short frame 1060 that omits some of the fields of the standard frame and one or more of the fields in the short frame 1060 are truncated or compressed. In the embodiment illustrated in FIG. 1A, the short frame comprises a MAC header 1061 followed by a frame body field 1084 and a frame check sequence (FCS) field 1086. The frame body field 1084 may comprise one or more information elements. The frame body 1084 may be a variable number of octets such as zero to 2312 octets like a frame body of a standard frame and may include data elements, control elements, or parameters and capabilities. The FCS field 1086 may be four octets such as the standard frame and may include extra checksum characters added to the short frame 1060 for error detection and correction.

The MAC header 1061 may comprise the frame control field 1062, an address (ADDR) field 1074, an ADDR field 1076, a Sequence Control (SEQ CTL) field 1080, an ADDR field 1078, and an ADDR field 1082. The frame control field 1062 may be two octets such as the standard frame and may identify the type and subtype of the frame such as a management type and beacon subtype.

One or more of the fields ADDR 1076, ADDR 1078, Sequence Control 1080, ADDR 1082, and frame body 1084 may only be present in certain frame types and subtypes of the short frames as is the case for standard frames. In further embodiments, short frames may comprise one or more other fields and/or one or more of these fields with a truncated or compressed format with respect to the fields of the corresponding standard frame.

The frame control field 1062 may comprise a protocol version field 1064, a type field 1066, other frame control bits 1070, and an ACK policy field 1068. The protocol version field 1064 may be two bits in length (B0-B1). The value of the protocol version field 1064 may represent the revision of the corresponding standard that the frame represents. The type field 1066 may be two bits in length (B2-B3) and may identify the type of short frame 1060 such as, e.g., a management frame or a data frame. The ACK policy field 1068 may be two bits in length (B14-B15) and may have a value to identify one of the available ACK policies such as a normal ACK, a no ACK, and a block ACK. And the other bits 1070 may be used for additional frame control field parameters. Note that short frame 1060 illustrates one embodiment of the short frame. Other short frames may include fields that are arranged differently or that may include or omit some of the aforementioned fields.

FIG. 1B illustrates an embodiment of a frame control field 1100 suitable for the short frame format 1060. As shown in FIG. 1B, the frame control field 400 may comprise a protocol version subfield 1104 with two bits (B0-B1), a type subfield 1106 with two bits (B2-B3), a from distribution system (DS) subfield 1108 with one bit (B4), a more fragments subfield 1110 with one bit (B5), a power management subfield 1112 with one bit (B6), a more data subfield 1114 with one bit (B7), a protected frame subfield 1116 with one bit (B8), an end of service period subfield 1118 with one bit (B9), a relayed frame subfield 1120 with one bit (B10), a traffic identifier (TID) subfield 1122 with three bits (B11-B13), and an acknowledgement policy subfield 1124 with two bit (B14-B15). The fields and field sizes are exemplary, and a given implementation of the frame control field 1100 may have different fields and field sizes. Embodiments are not limited in this context.

As shown in FIG. 1B, the frame control field 1100 has two significant differences from the frame control field of the current short frame defined in IEEE 802.11ah. First, the type subfield 1106 of the frame control field 1100 is two bits long, whereas the type subfield of the frame control field of the current short frame defined in IEEE 802.11ah is four bits long. Second, the released two bits of the type subfield of the current short frame defined in IEEE 802.11ah are reallocated to a new acknowledgment subfield 1124 of the frame control field 1100.

The acknowledgement policy subfield 1124 may be used to provide the short MAC frame format 1060 with acknowledgement policy information. The acknowledgement policy subfield 1124 may indicate whether a particular acknowledgement policy could be used for a given connection, device or system for a WLAN system, such as an IEEE 802.11ah WLAN system, for example. For instance, a device could use a normal acknowledgement (ACK) scheme, a block ACK scheme, or no ACK scheme at all. In one embodiment, the same acknowledgement policy field definitions may be used for the acknowledgement policy subfield 1124 as defined in any of the IEEE 802.11 series of standards, including progeny, revisions and variants, or even any other wireless communications protocol. The presence of the acknowledgement policy field in the short MAC frame format 1060 may lead to more reliable communications, particularly for QoS applications. Other frame control fields for short frames may include fields that are arranged differently or that may include or omit some of the aforementioned fields.

Referring again to FIG. 1, the MAC sublayer logic 1018, 1038 may comprise logic to implement functionality of the MAC sublayer of the data link layer of the communications device 1010, 1030. The MAC sublayer logic 1018, 1038 may generate the frames such as short management frames, short data frames, and, in some embodiments, short control frames, and may communicate with the PHY logic 1029, 1039 to indicate that these frames are short frames 1014, 1034. The PHY logic 1029, 1039 may generate physical layer protocol data units (PPDUs) based upon the short frames 1014, 1034. More specifically, the frame builders 1013 and 1033 may generate short frames 1014, 1034 and the data unit builders 1015, 1035 of the PHY logic 1029, 1039 may prepend the short frames 1014, 1034 with preambles 1016, 1036 to generate PPDUs for transmission via a physical layer device such as the transceivers (RX/TX) 1020 and 1040.

The short frame 1014, also referred to as MAC layer Service Data Units (MSDUs), may comprise, e.g., a management frame. For example, frame builder 1013 may generate a management frame such as the short beacon frame to identify the communications device 1010 as having capabilities such as supported data rates, power saving features, cross-support, and a service set identification (SSID) of the network to identify the network to the communications device 1030.

The communications devices 1010, 1030, 1050, and 1055 may each comprise a transceiver such as transceivers (RX/TX) 1020 and 1040. In many embodiments, transceivers 1020 and 1040 implement orthogonal frequency-division multiplexing (OFDM) 1022, 1042. OFDM 1022, 1042 implements a method of encoding digital data on multiple carrier frequencies. OFDM 1022, 1042 comprises a frequency-division multiplexing scheme used as a digital multi-carrier modulation method. A large number of closely spaced orthogonal subcarrier signals are used to carry data. The data is divided into several parallel data streams or channels, one for each subcarrier. Each subcarrier is modulated with a modulation scheme at a low symbol rate, maintaining total data rates similar to conventional single-carrier modulation schemes in the same bandwidth.

An OFDM system uses several carriers, or “tones,” for functions including data, pilot, guard, and nulling Data tones are used to transfer information between the transmitter and receiver via one of the channels. Pilot tones are used to maintain the channels, and may provide information about time/frequency and channel tracking. And guard tones may help the signal conform to a spectral mask. The nulling of the direct component (DC) may be used to simplify direct conversion receiver designs. And guard intervals may be inserted between symbols such as between every OFDM symbol as well as between the short training field (STF) and long training field (LTF) symbols in the front end of the transmitter during transmission to avoid inter-symbol interference (ISI), which might result from multi-path distortion.

Each transceiver 1020, 1040 comprises a radio 1025, 1045 comprising an RF transmitter and an RF receiver. The RF transmitter comprises an OFDM 1022, which impresses digital data, OFDM symbols encoded with tones, onto RF frequencies, also referred to as subcarriers, for transmission of the data by electromagnetic radiation. In the present embodiment, the OFDM 1022 may impress the digital data as OFDM symbols encoded with tones onto the subcarriers to for transmission. The OFDM 1022 may transform information signals into signals to be applied via the radio 1025, 1045 to elements of an antenna array 1024. An RF receiver receives electromagnetic energy at an RF frequency and extracts the digital data from the OFDM symbols.

In some embodiments, the communications device 1010 optionally comprises a Digital Beam Former (DBF) 1023, as indicated by the dashed lines. In some embodiments, the DBF 1023 may be part of the OFDM 1022. The DBF 1023 provides spatial filtering and is a signal processing technique used with antenna array 1024 for directional signal transmission or reception. This is achieved by combining elements in a phased antenna array 1024 in such a way that signals at particular angles experience constructive interference while others experience destructive interference. Beamforming can be used at both the transmitting and receiving ends in order to achieve spatial selectivity. The antenna array 1024 is an array of individual, separately excitable antenna elements. The signals applied to the elements of the antenna array 1024 cause the antenna array 1024 to radiate one to four spatial channels. Each spatial channel so formed may carry information to one or more of the communications devices 1030, 1050, and 1055. Similarly, the communications device 1030 comprises the transceiver (RX/TX) 1040 to receive and transmit signals from and to the communications device 1010. The transceiver (RX/TX) 1040 may comprise an antenna array 1044 and, optionally, a DBF 1042.

FIG. 1 may depict a number of different embodiments including a Multiple-Input, Multiple-Output (MIMO) system with, e.g., four spatial streams, and may depict degenerate systems in which one or more of the communications devices 1010, 1030, 1050, and 1055 comprise a receiver and/or a transmitter with a single antenna including a Single-Input, Single Output (SISO) system, a Single-Input, Multiple Output (SIMO) system, and a Multiple-Input, Single Output (MISO) system. In the alternative, FIG. 1 may depict transceivers that include multiple antennas and that may be capable of multiple-user MIMO (MU-MIMO) operation.

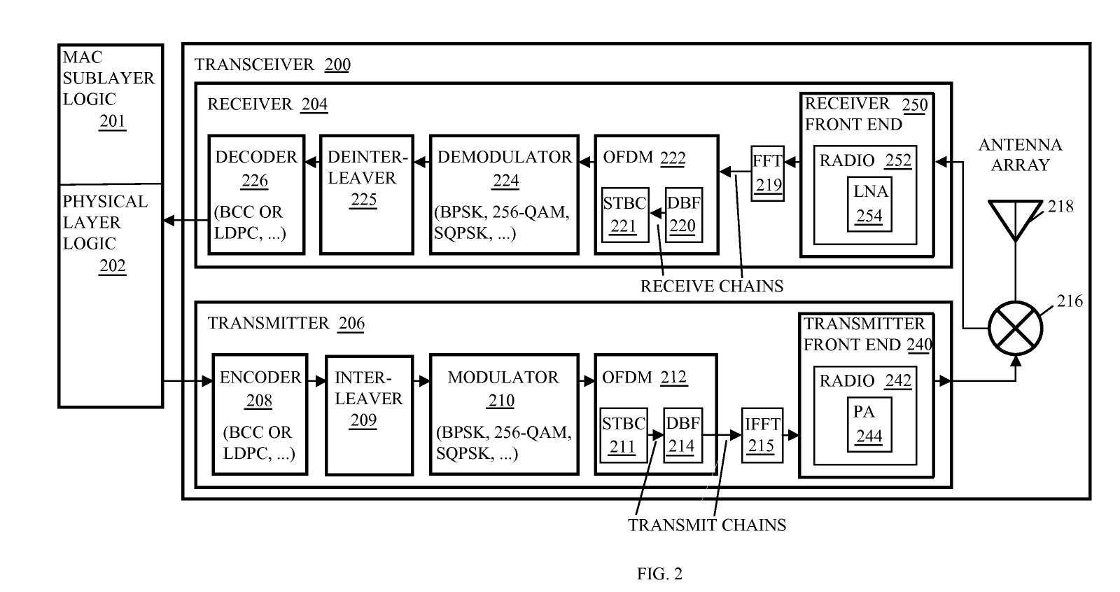

FIG. 2 depicts an embodiment of an apparatus to generate, transmit, receive, and interpret or decode frames including short frames such as the short frames described in conjunction with FIGS. 1A-1B. The apparatus comprises a transceiver 200 coupled with Medium Access Control (MAC) sublayer logic 201 and a physical layer (PHY) logic 202. The MAC sublayer logic 201 may determine a short frame and the physical layer (PHY) logic 202 may determine the PPDU by prepending the frame or multiple frames, also called MAC protocol data units (MPDUs), with a preamble to transmit via transceiver 200. For example, a frame builder may generate a frame including a type field that specifies the type of the frame such as a management, control, or data frame and an ACK policy field to the ACK policy associated with the frame. A control frame may include a Ready-To-Send or Clear-To-Send frame. A management frame may comprise a Beacon,

Probe Request/Response, Association Request/Response, and Reassociation Request/Response frame type. And the data type frame is designed to transmit data.

In many embodiments, the MAC sublayer logic 201 may comprise a frame builder 202 to generate frames (MPDU) such as one of the short frames illustrated in FIGS. 1A-B. The short frames may comprise fields that are truncated/compressed or omitted with respect to a standard frame. For instance, a truncated/compressed field may comprise less bits than a corresponding field in a standard frame because some bits of the field were not being used for the short frame, the information relevant to the short frame can be conveyed with less bits, or the information represented by the removed bits is not being transmitted with the short frame.

In the present embodiment, the short frame may comprise a type field that is two bits in length and an ACK policy field that is two bits in length. The ACK policy field may indicate whether a particular ACK policy should be used for a given connection, device or system. For instance, a device could use a normal acknowledgement scheme, a block ACK scheme, or no ACK scheme at all.

The short frame structures, field values, and/or the short frames may be maintained by an access point such as communications device 1010 and a station such as communications device 1030 in FIG. 1 in memory 1012, 1032. For example, in some embodiments, a frame builder 202 may generate a short frame with a short MAC header defined in memory of the communications device and the MAC sublayer logic 201 may transmit the short frame to the PHY logic 202.

The PHY logic 202 may comprise a data unit builder 203. The data unit builder 203 may determine a preamble with the bit set to indicate that the frame is a short frame and the PHY logic 202 may prepend the MPDU with the preamble to generate a PPDU. In many embodiments, the data unit builder 203 may create the preamble based upon communications parameters chosen through interaction with a destination communications device.

The transceiver 200 comprises a receiver 204 and a transmitter 206. The transmitter 206 may comprise one or more of an encoder 208, a modulator 210, an OFDM 212, and a DBF 214. The encoder 208 of transmitter 206 receives and encodes data destined for transmission from the MAC sublayer logic 202 with, e.g., a binary convolutional coding (BCC), a low density parity check coding (LDPC), and/or the like. The modulator 210 may receive data from encoder 208 and may impress the received data blocks onto a sinusoid of a selected frequency via, e.g., mapping the data blocks into a corresponding set of discrete amplitudes of the sinusoid, or a set of discrete phases of the sinusoid, or a set of discrete frequency shifts relative to the frequency of the sinusoid.

The output of modulator 209 is fed to an orthogonal frequency division multiplexing (OFDM) module 212. The OFDM module 212 may comprise a space-time block coding (STBC) module 211, a digital beamforming (DBF) module 214, and an inverse, fast Fourier transform (IFFT) module 215. The STBC module 211 may receive constellation points from the modulator 209 corresponding to one or more spatial streams and may spread the spatial streams to a greater number of space-time streams (also generally referred to as data streams). Further embodiments may omit the STBC.

The OFDM module 212 impresses or maps the modulated data formed as OFDM symbols onto a plurality of orthogonal subcarriers so the OFDM symbols are encoded with the subcarriers or tones. In some embodiments, the OFDM symbols are fed to the Digital Beam Forming (DBF) module 214. Generally, digital beam forming uses digital signal processing algorithms that operate on the signals received by, and transmitted from, an array of antenna elements.

The Inverse Fast Fourier Transform (IFFT) module 215 may perform an inverse discrete Fourier transform (IDFT) on the OFDM symbols. The output of the IFFT module 215 may enter the transmitter front end 240. The transmitter front end 240 may comprise a radio 242 with a power amplifier (PA) 244 to amplify the signal and prepare the signal for transmission via the antenna array 218.

In one embodiment, the radio 242, 252 may include a component or combination of components adapted for transmitting and/or receiving single carrier or multi-carrier modulated signals (e.g., including complementary code keying (CCK) and/or orthogonal frequency division multiplexing (OFDM) symbols) although the embodiments are not limited to any specific over-the-air interface or modulation scheme. The radio 242, 252 may include, for example, a receiver, a transmitter and/or a frequency synthesizer. The radio 242, 252 may include, for instance, bias controls, and a crystal oscillator, and may couple with one or more antennas 218. In another embodiment, the radio 242 may use external voltage-controlled oscillators (VCOs), surface acoustic wave filters, intermediate frequency (IF) filters and/or RF filters, as desired. Due to the variety of potential RF interface designs an expansive description thereof is omitted.

The signal may be up-converted to a higher carrying frequency or may be performed integrally with up-conversion. Shifting the signal to a much higher frequency before transmission enables use of an antenna array of practical dimensions. That is, the higher the transmission frequency, the smaller the antenna can be. Thus, an up-converter multiplies the modulated waveform by a sinusoid to obtain a signal with a carrier frequency that is the sum of the central frequency of the waveform and the frequency of the sinusoid.

The transceiver 200 may also comprise duplexers 216 connected to antenna array 218. Thus, in this embodiment, a single antenna array is used for both transmission and reception. When transmitting, the signal passes through duplexers 216 and drives the antenna with the up-converted information-bearing signal. During transmission, the duplexers 216 prevent the signals to be transmitted from entering receiver 204. When receiving, information bearing signals received by the antenna array pass through duplexers 216 to deliver the signal from the antenna array to receiver 204. The duplexers 216 then prevent the received signals from entering transmitter 206. Thus, duplexers 216 operate as switches to alternately connect the antenna array elements to the receiver 204 and the transmitter 206.

The antenna array 218 radiates the information bearing signals into a time-varying, spatial distribution of electromagnetic energy that can be received by an antenna of a receiver. The receiver can then extract the information of the received signal. In other embodiments, the transceiver 200 may comprise one or more antennas rather than antenna arrays and, in several embodiments, the receiver 204 and the transmitter 206 may comprise their own antennas or antenna arrays.

The transceiver 200 may comprise a receiver 204 for receiving, demodulating, and decoding information bearing communication signals. The receiver 204 may comprise a receiver front-end to detect the signal, detect the start of the packet, remove the carrier frequency, and amplify the subcarriers via a radio 252 with a low noise amplifier (LNA) 254. The communication signals may comprise, e.g., 32 tones on a 1 MHz carrier frequency. The receiver 204 may comprise a fast Fourier transform (FFT) module 219. The FFT module 219 may transform the communication signals from the time domain to the frequency domain.

The receiver 204 may also comprise an OFDM module 222, a demodulator 224, a deinterleaver 225, and a decoder 226, and the equalizer 258 may output the weighted data signals for the OFDM packet to the OFDM module 222. The OFDM 222 extracts signal information as OFDM symbols from the plurality of subcarriers onto which information-bearing communication signals are modulated.

The OFDM module 222 may comprise a DBF module 220, and an STBC module 221. The received signals are fed from the equalizer to the DBF module 220. The DBF module 220 may comprise algorithms to process the received signals as a directional transmission directed toward to the receiver 204. And the STBC module 221 may transform the data streams from the space-time streams to spatial streams.

The demodulator 224 demodulates the spatial streams. Demodulation is the process of extracting data from the spatial streams to produce demodulated spatial streams. The method of demodulation depends on the method by which the information is modulated onto the received carrier signal and such information is included in the transmission vector (TXVECTOR) included in the communication signal. Thus, for example, if the modulation is BPSK, demodulation involves phase detection to convert phase information to a binary sequence. Demodulation provides to the deinterleaver 225 a sequence of bits of information.

The deinterleaver 225 may deinterleave the sequence of bits of information. For instance, the deinterleaver 225 may store the sequence of bits in columns in memory and remove or output the bits from the memory in rows to deinterleave the bits of information. The decoder 226 decodes the deinterleaved data from the demodulator 224 and transmits the decoded information, the MPDU, to the MAC sublayer logic 202.

Persons of skill in the art will recognize that a transceiver may comprise numerous additional functions not shown in FIG. 2 and that the receiver 204 and transmitter 206 can be distinct devices rather than being packaged as one transceiver. For instance, embodiments of a transceiver may comprise a Dynamic Random Access Memory (DRAM), a reference oscillator, filtering circuitry, synchronization circuitry, an interleaver and a deinterleaver, possibly multiple frequency conversion stages and multiple amplification stages, etc. Further, some of the functions shown in FIG. 2 may be integrated. For example, digital beam forming may be integrated with orthogonal frequency division multiplexing.

The MAC sublayer logic 201 may parse the MPDU based upon a format defined in the communications device for a short frame to determine the particular type of frame by determining the type value and the subtype value. The MAC sublayer logic 201 may then parse and interpret the remainder of MPDU based upon the definition for the short frame of the particular type and subtype indicated in the MAC header. For instance, if the short frame is a short management frame, the frame body may include parameters to set for communication preferences for the source station of the transmission. In some embodiments, the frame body may include information related to traffic preferences such as traffic for which the source station requests that the access point respond on behalf of the source station.

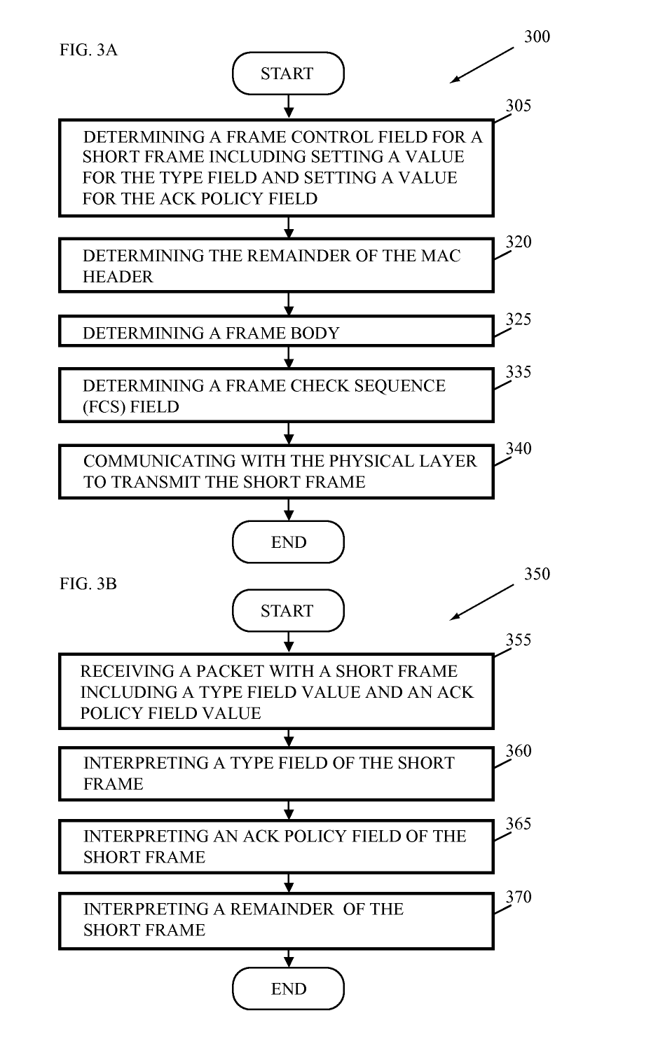

FIG. 3A-B depict embodiments of flowcharts to generate a short frame, generate a preamble to prepend the short frame, transmit the short frame between communications devices, indicate that the frame is a short frame via communication between MAC sublayer logic and PHY logic, and parse and interpret the short frame. In particular, FIG. 3A depicts an embodiment of a flowchart 300 to generate or otherwise determine a short frame. The flowchart 300 begins with a medium access control (MAC) sublayer logic determining a frame control field for a short frame (element 305). In some embodiments, the MAC sublayer logic may determine a protocol version field to be the current revision of the standard, a type being a data frame such as 00 or a management frame such as a value of 01, a subtype being a beacon such as a value of 100 in the traffic identifier (TID) field. In many embodiments, the MAC sublayer logic may determine an ACK policy and insert the appropriate ACK policy field value into the ACK policy field such as a value of 00 to indicate a normal ACK or an implicit ACK, a value of 01 to indicate no explicit ACK, a value of 10 to indicate no ACK, or a value of 11 to indicate an explicit Block ACK.

In some embodiments, the MAC sublayer logic may determine one or more truncated values such as a truncated address value by, e.g., utilizing the least significant two octets of the address. In other embodiments, the MAC sublayer logic may determine a truncated or compressed value by hashing the value or otherwise compressing the value in a manner that can be decoded by the receiving communications device.

The MAC sublayer logic may determine the remainder of the short frame (element 320). For example, the MAC sublayer logic may generate the remainder of the frame control field and the remainder of the MAC header such as the TID field value, more fragments, field value, a power management field value, a protected frame field value, a more data field value, and/or the like. The MAC sublayer logic may determine the frame body (element 325). In many embodiments, determining the fields may comprise retrieving these fields from a storage medium such as memory 1012 illustrated in FIG. 1 for inclusion in a frame. In other embodiments, the values to include in such fields may be stored in a storage medium such as a read only memory, random access memory, a cache, a buffer, a register, or the like. In further embodiments, one or more of the fields may be hardcoded into the MAC sublayer logic, PHY logic, or may otherwise be available for insertion into a frame. In still other embodiments, the MAC sublayer logic may generate the values of the fields of the short beacon frame based upon access to indications of the values for each.

After determining the other portions of the short frame, the MAC sublayer logic may determine a frame check sequence (FCS) field value (element 335) to provide for error corrections at the access point.

Either during or after the MAC sublayer logic may determine the short frame, the MAC sublayer logic may also communicate with the physical layer (PHY) logic to transmit the short frame (element 340). In some embodiments, the MAC sublayer logic may transmit a field value to the PHY logic to indicate that the frame is a short frame.

FIG. 3B depicts an embodiment of a flowchart 300 to receive, decode, parse and interpret, or otherwise determine a short frame. The flowchart 300 begins with a PHY logic receiving a communication that includes the short frame, decoding the communication to determine the MAC payload, which is the short frame and transmitting the short frame to the MAC sublayer logic for further processing (element 355). The PHY logic may detect the communication by detection of an energy level at the receiver front end and, in response, begin processing the incoming OFDM packet. After processing the packet, the PHY layer data may be removed and the short frame may be transmitted to the MAC sublayer logic. In some embodiments, the communication may include multiple MAC frames as payloads. In several embodiments, these MAC frames may be transmitted to the MAC sublayer logic a frame at a time as the frames are decoded.

After receiving a short frame from the PHY logic, the MAC sublayer may parse and interpret the field values from the short frame. For instance, the first field may be the frame control field and the first subfield may be the protocol version subfield. The MAC sublayer logic may access memory to determine the frame structure of the short frame if the value in the protocol version is compatible with the software or firmware of the MAC sublayer logic by comparing the protocol version with the protocol version(s) supported by the MAC sublayer logic. After parsing and interpreting the protocol version subfield, the MAC sublayer logic may parse and interpret the type subfield to determine the type of the short frame (element 360). The MAC sublayer logic may parse the short frame by identifying bits of the frame with field values in the short frame format, which may be stored in memory accessible to the MAC sublayer logic. Upon retrieving the value of the type subfield, the MAC sublayer logic may interpret the value by comparing the value to known values for the type subfield to identify the short frame type.

After interpreting the type subfield, the MAC sublayer logic may be more specifically aware of the short frame format for further parsing so the MAC sublayer logic may continue parsing and interpreting the short frame in a similar manner. For instance, the MAC sublayer logic may parse and interpret the ACK policy subfield to determine the appropriate ACK policy to implement upon receipt of the short frame (element 365). Many embodiments have three or more ACK policies and other embodiments may have three or less different policies. Furthermore, the MAC sublayer logic may continue to parse and interpret the remainder of the fields and subfields in the short frame (element 370).

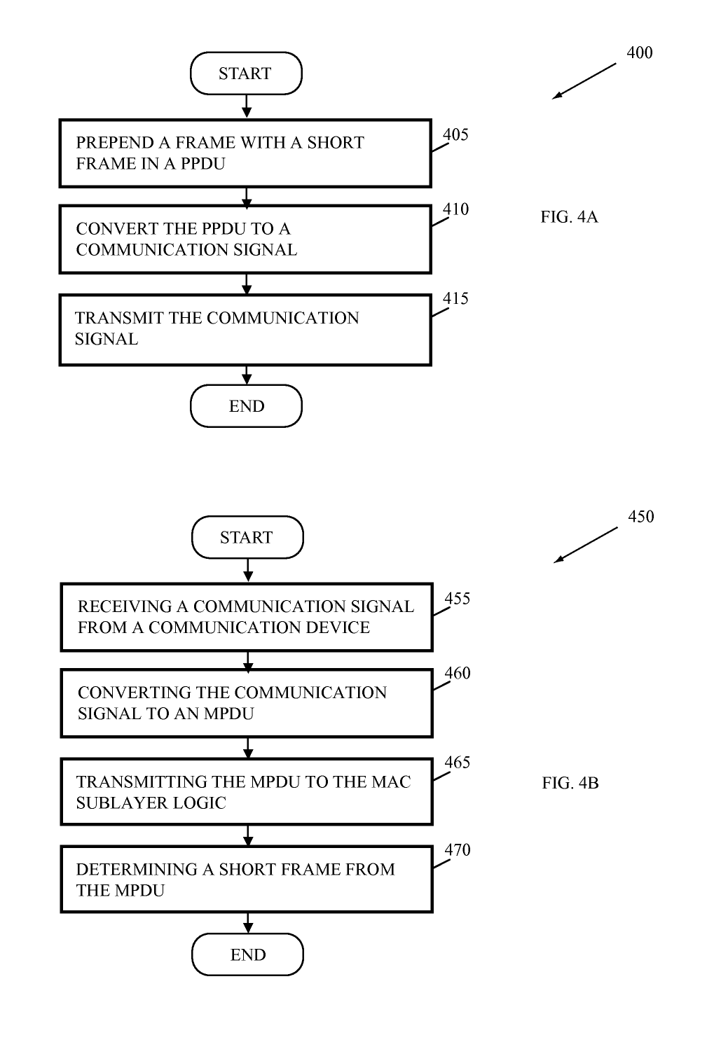

FIGS. 4A-B depict embodiments of flowcharts 400 and 450 to transmit, receive, and interpret communications with a short frame with an ACK policy field for signaling an ACK policy as the short frames illustrated in FIGS. 1A-B. Referring to FIG. 4A, the flowchart 400 may begin with receiving a frame from the frame builder. The MAC sublayer logic of the communications device may generate the frame as a management frame to transmit to an access point and may pass the frame as an MAC protocol data unit (MPDU) to a data unit builder that transforms the data into a packet that can be transmitted to the access point. The data unit builder may generate a preamble to prepend the PHY service data unit (PSDU) (the MPDU from the frame builder) to form a PHY protocol data unit (PPDU) for transmission (element 405). In some embodiments, more than one MPDU may be prepended in a PPDU. Such embodiments may include a bit indicative of whether particular MPDUs or all MPDUs comprise short frame.

The PPDU may then be transmitted to the physical layer device such as the transmitter 206 in FIG. 2 or the transceiver 1020, 1040 in FIG. 1 so the PPDU may be converted to a communication signal (element 410). The transmitter may then transmit the communication signal via the antenna (element 415).

Referring to FIG. 4B, the flowchart 450 begins with a receiver of an access point such as the receiver 204 in FIG. 2 receiving a communication signal via one or more antenna(s) such as an antenna element of antenna array 218 (element 455). The receiver may convert the communication signal into an MPDU in accordance with the process described in the preamble (element 460). More specifically, the received signal is fed from the one or more antennas to a DBF such as the DBF 220. The DBF processes the received signal as a directional transmission directed toward to the receiver. The output of the DBF is fed to OFDM such as the OFDM 222. The OFDM extracts signal information from the plurality of subcarriers onto which information-bearing signals are modulated. Then, the demodulator such as the demodulator 224 demodulates the signal information via, e.g., BPSK, 16-QAM, 64-QAM, 256-QAM, QPSK, or SQPSK. And the decoder such as the decoder 226 decodes the signal information from the demodulator via, e.g., BCC or LDPC, to extract the MPDU (element 460) and transmits the MPDU to MAC sublayer logic such as MAC sublayer logic 202 (element 465). The PHY logic may also communicate with the MAC sublayer logic to indicate that the MPDU comprises a short frame.

The MAC sublayer logic may determine short frame field values from the MPDU (element 470) such as the short frame 1060 fields and the frame control field 1100 subfields in FIGS. 1A-B. For instance, the MAC sublayer logic may determine short frame field values such as the ACK policy field value of the short frame.

The following examples pertain to further embodiments. One example comprises an apparatus. The apparatus may comprise a medium access control logic to generate a short frame comprising a frame control field, the frame control field comprising a type subfield, the type subfield comprising two bits to describe a type of the short frame, wherein values of the type subfield comprise a value indicative of a management frame; and an acknowledgement policy subfield comprising two bits to describe acknowledgement policies; and a physical layer logic to prepend the frame with a preamble and to transmit the frame.

In some embodiments, the apparatus may further comprise a radio coupled with the physical layer logic and an antenna array to transmit the short frame prepended by the preamble. In some embodiments, the medium access control logic comprises logic to generate the short frame with a medium access control header having a structure defined for a short medium access control frame in accordance with Institute of Electrical and Electronic Engineers 802.11ah. In some embodiments, the medium access control logic comprises logic to generate the short frame, wherein the frame control field further comprises a traffic identifier subfield to identify a subtype of a management type of the short frame. In some embodiments, the medium access control logic comprises logic to generate the short frame with the acknowledgement policy subfield, wherein the acknowledgement policy subfield is capable of indicating at least three different acknowledgement policies.

Another embodiment comprises one or more tangible computer-readable non-transitory storage media comprising computer-executable instructions operable to, when executed by at least one computer processor, enable the at least one computer processor to implement a method. The method may comprise generating a short frame comprising a frame control field, the frame control field comprising a type subfield, the type subfield comprising two bits to describe a type of the short frame, wherein values of the type subfield comprise a value indicative of a management frame; and an acknowledgement policy subfield comprising two bits to describe acknowledgement policies.

In some embodiments, generating the short frame with a medium access control header having a structure defined for a short medium access control frame in accordance with Institute of Electrical and Electronic Engineers 802.11ah. In some embodiments, generating the short frame comprises generating a traffic identifier subfield to identify a subtype of a management type of the short frame in the frame control field. In some embodiments, generating the short frame comprises generating the short frame with the acknowledgement policy subfield, wherein the acknowledgement policy subfield is capable of indicating at least three different acknowledgement policies.

Another embodiment comprises a method to transmit a packet. The method may comprise generating a short frame comprising a frame control field, the frame control field comprising a type subfield, the type subfield comprising two bits to describe a type of the short frame, wherein values of the type subfield comprise a value indicative of a management frame; and an acknowledgement policy subfield comprising two bits to describe acknowledgement policies; and transmitting the short frame.

In some embodiments, generating the short frame comprises generating the short frame with a medium access control header having a structure defined for a short medium access control frame in accordance with Institute of Electrical and Electronic Engineers 802.11ah. In some embodiments, generating the short frame comprises generating a traffic identifier subfield to identify a subtype of a management type of the short frame in the frame control field. In some embodiments, generating the short frame comprises generating the short frame with the acknowledgement policy subfield, wherein the acknowledgement policy subfield is capable of indicating at least three different acknowledgement policies.

Another embodiment comprises a system to transmit a packet. The system may comprise a processor; a memory coupled with the processor; a medium access control logic to generate a short frame comprising a frame control field, the frame control field comprising a type subfield, the type subfield comprising two bits to describe a type of the short frame, wherein values of the type subfield comprise a value indicative of a management frame; and an acknowledgement policy subfield comprising two bits to describe acknowledgement policies; and a radio coupled with the medium access control logic; and one or more antennas coupled with the radio to transmit the frame.

In some embodiments, the medium access control logic comprises logic to generate the short frame with a medium access control header having a structure defined for a short medium access control frame in accordance with Institute of Electrical and Electronic Engineers 802.11ah. In some embodiments, the medium access control logic comprises logic to generate the short frame, wherein the frame control field further comprises a traffic identifier subfield to identify a subtype of a management type of the short frame. In some embodiments, the medium access control logic comprises logic to generate the short frame with the acknowledgement policy subfield, wherein the acknowledgement policy subfield is capable of indicating at least three different acknowledgement policies.

Another embodiment comprises an apparatus to interpret a packet. The apparatus may comprise a memory; logic coupled with the memory to interpret a short frame comprising a frame control field, the frame control field comprising a type subfield, the type subfield comprising two bits to describe a type of the short frame; and an acknowledgement policy subfield comprising two bits to describe acknowledgement policies; to determine a value in the type subfield of the short frame is indicative of a management frame; and to determine a value in the acknowledgement policy subfield is indicative of one of the acknowledgement policies.

In some embodiments, the logic comprises logic to interpret the short frame with a medium access control header having a structure defined for a short medium access control frame in accordance with Institute of Electrical and Electronic Engineers 802.11ah. In some embodiments, the logic comprises logic to interpret the short frame, wherein the frame control field further comprises a traffic identifier subfield to identify a subtype of a management type of the short frame. In some embodiments, the logic comprises logic to interpret the short frame with the acknowledgement policy subfield, wherein the acknowledgement policy subfield is capable of indicating at least three different acknowledgement policies.

Another embodiment comprises one or more tangible computer-readable non-transitory storage media comprising computer-executable instructions operable to, when executed by at least one computer processor, enable the at least one computer processor to implement a method. The method may comprise interpreting a short frame comprising a frame control field, the frame control field comprising a type subfield, the type subfield comprising two bits to describe a type of the short frame and an acknowledgement policy subfield comprising two bits to describe acknowledgement policies, wherein interpreting the short frame comprises interpreting the type subfield to determine a value of the type of the short frame is indicative of a management frame and interpreting the acknowledgement policy subfield to determine a value indicative of one of the acknowledgement policies.

In some embodiments, interpreting the short frame comprises interpreting the short frame with a medium access control header having a structure defined for a short medium access control frame in accordance with Institute of Electrical and Electronic Engineers 802.11ah. In some embodiments, interpreting the short frame comprises interpreting a traffic identifier subfield to identify a subtype of a management type of the short frame. In some embodiments, interpreting the short frame comprises interpreting the acknowledgement policy subfield to identify one acknowledgement policy of at least three different acknowledgement policies based upon a value in the acknowledgement policy subfield.

Another embodiment comprises a system to interpret a packet. The system may comprise a processor; a memory coupled with the processor; logic coupled with the memory to interpret a short frame comprising a frame control field, the frame control field comprising a type subfield, the type subfield comprising two bits to describe a type of the short frame; and an acknowledgement policy subfield comprising two bits to describe acknowledgement policies; to determine a value in the type subfield of the short frame is indicative of a management frame; and to determine a value in the acknowledgement policy subfield is indicative of one of the acknowledgement policies; a radio coupled with the medium access control logic; and one or more antennas coupled with the radio to transmit the frame.

In some embodiments, the logic comprises logic to interpret the short frame with a medium access control header having a structure defined for a short medium access control frame in accordance with Institute of Electrical and Electronic Engineers 802.11ah. In some embodiments, the logic comprises logic to interpret the short frame, wherein the frame control field further comprises a traffic identifier subfield to identify a subtype of a management type of the short frame. In some embodiments, the logic comprises logic to interpret the short frame with the acknowledgement policy subfield, wherein the acknowledgement policy subfield is capable of indicating at least three different acknowledgement policies.

Another embodiment comprises a method to interpret a packet. The method may comprise receiving, by a station, the packet comprising a short frame, wherein the short frame comprising a frame control field, the frame control field comprising a type subfield, the type subfield comprising two bits to describe a type of the short frame, wherein values of the type subfield comprise a value indicative of a management frame; and an acknowledgement policy subfield comprising two bits to describe acknowledgement policies; interpreting, by the station, the short frame, wherein interpreting the short frame comprises interpreting the type subfield to determine a value of the type of the short frame is indicative of a management frame; and interpreting, by the station, the acknowledgement policy subfield to determine an value indicative of one of the acknowledgement policies.

In some embodiments, interpreting the short frame comprises interpreting the short frame with a medium access control header having a structure defined for a short medium access control frame in accordance with Institute of Electrical and Electronic Engineers 802.11ah. In some embodiments, interpreting the short frame comprises interpreting a traffic identifier subfield to identify a subtype of a management type of the short frame. In some embodiments, interpreting the short frame comprises the acknowledgement policy subfield to identify one acknowledgement policy of at least three different acknowledgement policies based upon a value in the acknowledgement policy subfield.

Another embodiment comprises an apparatus to transmit a packet. The apparatus may comprise a means for generating a short frame comprising a frame control field, the frame control field comprising a type subfield, the type subfield comprising two bits to describe a type of the short frame, wherein values of the type subfield comprise a value indicative of a management frame; and an acknowledgement policy subfield comprising two bits to describe acknowledgement policies; and a means for transmitting the short frame.

In some embodiments, the means for generating the short frame comprises a means for generating the short frame with a medium access control header having a structure defined for a short medium access control frame in accordance with Institute of Electrical and Electronic Engineers 802.11ah. In some embodiments, the means for generating the short frame comprises a means for generating a traffic identifier subfield to identify a subtype of a management type of the short frame in the frame control field. In some embodiments, the means for generating the short frame comprises a means for generating the short frame with the acknowledgement policy subfield, wherein the acknowledgement policy subfield is capable of indicating at least three different acknowledgement policies.

Another embodiment comprises an apparatus to interpret a packet. The apparatus may comprise a means for receiving the packet comprising a short frame, wherein the short frame comprising a frame control field, the frame control field comprising a type subfield, the type subfield comprising two bits to describe a type of the short frame, wherein values of the type subfield comprise a value indicative of a management frame; and an acknowledgement policy subfield comprising two bits to describe acknowledgement policies; and a means for interpreting the short frame, wherein interpreting the short frame comprises interpreting the type subfield to determine a value of the type of the short frame is indicative of a management frame; and interpreting, by the station, the acknowledgement policy subfield to determine an value indicative of one of the acknowledgement policies.

In some embodiments, the means for interpreting the short frame comprises a means for interpreting the short frame with a medium access control header having a structure defined for a short medium access control frame in accordance with Institute of Electrical and Electronic Engineers 802.11ah. In some embodiments, the means for interpreting the short frame comprises a means for interpreting a traffic identifier subfield to identify a subtype of a management type of the short frame. In some embodiments, the means for interpreting the short frame comprises a means for interpreting the acknowledgement policy subfield to identify one acknowledgement policy of at least three different acknowledgement policies based upon a value in the acknowledgement policy subfield.

In some embodiments, some or all of the features described above and in the claims may be implemented in one embodiment. For instance, alternative features may be implemented as alternatives in an embodiment along with logic or selectable preference to determine which alternative to implement. Some embodiments with features that are not mutually exclusive may also include logic or a selectable preference to activate or deactivate one or more of the features.

For instance, some features may be selected at the time of manufacture by including or removing a circuit pathway or transistor. Further features may be selected at the time of deployment or after deployment via logic or a selectable preference such as a dipswitch or the like. A user after via a selectable preference such as a software preference, an e-fuse, or the like may select still further features.

A number of embodiments may have one or more advantageous effects. For instance, some embodiments may offer reduced MAC header sizes with respect to standard MAC header sizes. Further embodiments may include one or more advantageous effects such as smaller packet sizes for more efficient transmission, lower power consumption due to less data traffic on both the transmitter and receiver sides of communications, less traffic conflicts, less latency awaiting transmission or receipt of packets, and the like.

Another embodiment is implemented as a program product for implementing systems and methods described with reference to FIGS. 1-4. Some embodiments can take the form of an entirely hardware embodiment, an entirely software embodiment, or an embodiment containing both hardware and software elements. One embodiment is implemented in software, which includes but is not limited to firmware, resident software, microcode, etc.

Furthermore, embodiments can take the form of a computer program product (or machine-accessible product) accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device). Examples of a computer-readable medium include a semiconductor or solid-state memory, magnetic tape, a removable computer diskette, a random access memory (RAM), a read-only memory (ROM), a rigid magnetic disk, and an optical disk. Current examples of optical disks include compact disk—read only memory (CD-ROM), compact disk—read/write (CD-R/W), and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

The logic as described above may be part of the design for an integrated circuit chip. The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication.

The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a motherboard, or (b) an end product.

What is claimed is:

1. An apparatus to transmit a packet, the apparatus comprising:
a medium access control sublayer logic to generate a short frame comprising a frame control field, the frame control field comprising a type subfield, the type subfield comprising two bits to describe a type of the short frame; and an acknowledgement policy subfield comprising two bits to describe acknowledgement policies; and
a physical layer logic to prepend the frame with a preamble and to transmit the frame in a packet.

2. The apparatus of claim 1, further comprising a radio coupled with the physical layer logic and an antenna array to transmit the short frame prepended by the preamble.

3. The apparatus of claim 1, wherein the medium access control logic comprises logic to generate the short frame, wherein the frame control field further comprises a traffic identifier subfield to identify a subtype of a management type of the short frame.

4. The apparatus of claim 1, wherein the medium access control logic comprises logic to generate the short frame with the acknowledgement policy subfield, wherein the acknowledgement policy subfield is capable of indicating at least three different acknowledgement policies.

5. One or more tangible computer-readable non-transitory storage media comprising computer-executable instructions operable to, when executed by at least one computer processor, enable the at least one computer processor to implement a method comprising:
generating a short frame comprising a frame control field, the frame control field comprising a type subfield, the type subfield comprising two bits to describe a type of the short frame; and an acknowledgement policy subfield comprising two bits to describe acknowledgement policies.

6. The storage media of claim 5, wherein generating the short frame comprises generating a traffic identifier subfield to identify a subtype of a management type of the short frame in the frame control field.

7. The storage media of claim 5, wherein generating the short frame comprises generating the short frame with the acknowledgement policy subfield, wherein the acknowledgement policy subfield is capable of indicating at least three different acknowledgement policies.

8. A method to transmit a packet, the method comprising:
generating a short frame comprising a frame control field, the frame control field comprising a type subfield, the type subfield comprising two bits to describe a type of the short frame; and an acknowledgement policy subfield comprising two bits to describe acknowledgement policies; and
transmitting the short frame.

9. The method of claim 8, wherein generating the short frame comprises generating a traffic identifier subfield to identify a subtype of a management type of the short frame in the frame control field.

10. The method of claim 9, wherein generating the short frame comprises generating the short frame with the acknowledgement policy subfield, wherein the acknowledgement policy subfield is capable of indicating at least three different acknowledgement policies.

11. An apparatus to interpret a packet, the apparatus comprising:
a memory;
logic coupled with the memory to interpret a short frame comprising a frame control field, the frame control field comprising a type subfield, the type subfield comprising two bits to describe a type of the short frame; and an acknowledgement policy subfield comprising two bits to describe acknowledgement policies; to determine a value in the type subfield of the short frame is indicative of a frame type; and to determine a value in the acknowledgement policy subfield is indicative of one of the acknowledgement policies.

12. The apparatus of claim 11, wherein the logic comprises logic to interpret the short frame, wherein the frame control field further comprises a traffic identifier subfield to identify a subtype of a management type of the short frame.

13. The apparatus of claim 12, wherein the logic comprises logic to interpret the short frame with the acknowledgement policy subfield, wherein the acknowledgement policy subfield is capable of indicating at least three different acknowledgement policies.

14. One or more tangible computer-readable non-transitory storage media comprising computer-executable instructions operable to, when executed by at least one computer processor, enable the at least one computer processor to implement a method comprising:
interpreting a short frame comprising a frame control field, the frame control field comprising a type subfield, the type subfield comprising two bits to describe a type of the short frame and an acknowledgement policy subfield comprising two bits to describe acknowledgement policies, wherein interpreting the short frame comprises interpreting the type subfield to determine a value of the type of the short frame is indicative of frame type and interpreting, by the station, the acknowledgement policy subfield to determine an value indicative of one of the acknowledgement policies.

15. The storage media of claim 14, wherein interpreting the short frame comprises interpreting a traffic identifier subfield to identify a subtype of a management type of the short frame.

16. The storage media of claim 14, wherein interpreting the short frame comprises interpreting the acknowledgement policy subfield to identify one acknowledgement policy of at least three different acknowledgement policies based upon a value in the acknowledgement policy subfield.

17. A method to interpret a packet comprising:
receiving, by a station, the packet comprising a short frame, wherein the short frame comprising a frame control field, the frame control field comprising a type subfield, the type subfield comprising two bits to describe a type of the short frame; and an acknowledgement policy subfield comprising two bits to describe acknowledgement policies;
interpreting, by the station, the short frame, wherein interpreting the short frame comprises interpreting the type subfield to determine a value of the type of the short frame is indicative of a frame type; and interpreting, by the station, the acknowledgement policy subfield to determine an value indicative of one of the acknowledgement policies.

18. The method of claim 17, wherein interpreting the short frame comprises interpreting a traffic identifier subfield to identify a subtype of a management type of the short frame.

19. The method of claim 17, wherein interpreting the short frame comprises interpreting the acknowledgement policy subfield to identify one acknowledgement policy of at least three different acknowledgement policies based upon a value in the acknowledgement policy subfield.

20. A system to interpret a packet comprising:
a processor;
a memory coupled with the processor;
logic coupled with the memory to interpret a short frame comprising a frame control field, the frame control field comprising a type subfield, the type subfield comprising two bits to describe a type of the short frame; and an acknowledgement policy subfield comprising two bits to describe acknowledgement policies; to determine a value in the type subfield of the short frame is indicative of a frame type; and to determine a value in the acknowledgement policy subfield is indicative of one of the acknowledgement policies;
a radio coupled with the means for generating the frame; and
one or more antennas coupled with the radio to transmit the frame.

21. The system of claim 20, wherein the logic comprises logic to interpret the short frame, wherein the frame control field further comprises a traffic identifier subfield to identify a subtype of a management type of the short frame.

22. The system of claim 20, wherein the logic comprises logic to interpret the short frame with the acknowledgement policy subfield, wherein the acknowledgement policy subfield is capable of indicating at least three different acknowledgement policies.

23. A system to transmit a packet, the system comprising:
a processor;
a memory coupled with the processor;
a medium access control logic to generate a short frame comprising a frame control field, the frame control field comprising a type subfield, the type subfield comprising two bits to describe a type of the short frame; and an acknowledgement policy subfield comprising two bits to describe acknowledgement policies; and
a radio coupled with the medium access control logic; and
one or more antennas coupled with the radio to transmit the frame.

24. The system of claim 23, wherein the medium access control logic comprises logic to generate the short frame, wherein the frame control field further comprises a traffic identifier subfield to identify a subtype of a management type of the short frame.

25. The system of claim 23, wherein the medium access control logic comprises logic to generate the short frame with the acknowledgement policy subfield, wherein the acknowledgement policy subfield is capable of indicating at least three different acknowledgement policies.
